(19) United States
(12) Patent Application Publication
(10) Pub. No.: US 2004/0116155 A1
(43) Pub. Date: Jun. 17, 2004

(54) Cellular telephone back-up and media system

(76) Inventor: Alain Aisenberg, Aventura, FL (US)

Correspondence Address: MALLOY & MALLOY, P.A., 2800 S.W. Third Avenue, Historic Coral Way, Miami, FL, 33129, US

(21) Appl. No.: 10/317,892

(22) Filed: Dec. 12, 2002

(51) Int. Cl. H04M 1/00

(52) U.S. Cl. 455/558; 455/412.1

(57) ABSTRACT

A cellular telephone back up and media system that is structured for use with a cellular telephone of the type having an input structure and an internal memory on which a quantity of personal data is maintained. The back up and media system includes a memory module which contains a quantity of information and an external transfer module communicatively connected with the cellular telephone and defining an interface via which the memory module is communicatively connected with the internal memory of the cellular telephone. Transferring programming is further provided and is structured to direct the transfer of the personal information from the cellular telephone to the memory module as well as the transfer of information from the memory module to the internal memory of the cellular telephone.

### BACKGROUND OF THE INVENTION

1. Field of the Invention

The present invention relates to a cellular telephone back-up and media system which will allow large quantities of personal data stored on a cellular telephone to be effectively and conveniently backed up for safe keeping, and which will also allow for a substantially convenient and facilitated transfer of personal data between cellular telephones, including cellular telephones operating under different cellular telephone standards such as GSM and CDMA. The present system further achieves a convenient and facilitated means of providing additional information, including applications, bonus features, customization features, etc. to the cellular telephone for the benefit of the user.

2. Description of the Related Art

Since the advent of wireless technology, the use of cellular telephones has seen a substantial rise in usage and popularity. Moreover, this increase in usage has resulted in a significant increase in market competition and a significant increase in the functionality that is provided by cellular telephones and carriers.

Although the number and variety of features available utilizing cellular telephones is continuously increases, a primary function related to which significant advances have been made includes the ability and capacity of cellular telephones to store and make available a variety of personal data, including primarily information regarding contacts, calendar entries, games, photos, text messages, etc. Indeed, even the most basic cellular telephone are capable of storing hundreds of telephone numbers that have often taken months or even years to compile.

Despite, and possibly as a result of the continuous advances that have been made in the cellular telephone technology, a common occurrence that leads to one significant drawback associated the use of cellular telephones, is the fact that users often find themselves changing cellular telephones from time to time. These changes can take place merely so as to upgrade their telephone to one that is more compact or has higher functionality, or can come about as users change service plans between the numerous carriers that are now available, or if a user's cellular telephone becomes damaged, lost or stolen. Specifically, that significant drawback associated with the change in cellular telephones by a user includes the need for the user to manually transfer all of their personal information from one cellular telephone to another. In particular, although some presently available cellular telephones include very complex back-up procedure which may allowed a limited amount of back-up information to be stored as a list on a personal computer, such back-up systems do not truly alleviate the inconvenience associated with programming anew cellular telephone, especially if hundreds of contacts, dates and other information must be transferred. As such, it would be highly beneficial to provide a back-up system which not only helps to maintain a back-up of personal information, but which also helps to effectuate a transfer between the back-up source and a cellular telephone, whether it be an old or a new cellular telephone, and regardless of the cellular telephone standard utilized, thereby substantially facilitating a telephone transfer process.

Moreover, it is also recognized that with the increases in technology a variety of additional features are often being added to cellular telephones, and can qualify as personnel information a user may not want to lose. For example, it is becoming very common for individuals to obtain a variety of games, customized ring tones, and graphical elements, such as pictures, screen savers, icons, etc., for their cellular telephones. Further, such additional features must often be purchased by the user and specially transferred to the telephone by the seller. As such, it would be highly beneficial to provide a system whereby such additional personal information including but not limited to the ring tones, graphics, games, etc. can be effectively and easily transferred to the user's new or repaired cellular telephone, such that the resetting or purchase of a new cellular telephone does not result in the loss of the variety of purchased and/or created customization features, and/or with which these additional features can be provided in the first place.

### SUMMARY OF THE INVENTION

The present invention relates to a cellular telephone back-up system. In particular, the cellular telephone back-up system is configured for use with a cellular telephone of the type that has an input structure, such as a key pad, joystick, touch screen, etc., and includes an internal memory on which a quantity of personal data is maintained.

Specifically, the present cellular telephone back-up system includes a memory module. The memory module is preferably compact and interchangeable, is structured to contain a quantity of information thereon, and can be defined of varying storage capacities depending upon the needs of the user. The back-up system further comprises an interface. In particular, the interface is structured to communicatively connect the memory module with the internal memory of the cellular telephone, in at least one way, but preferably at least two way data transmitting communication.

The present back-up system further comprises transfer programming that may be accessible utilizing the input structure of the cellular telephone. Preferably, the transfer programming is structured to direct the information transfer between the internal memory of the cellular telephone and the memory module, thus allowing for the backing up of data from the internal memory of the cellular telephone to the memory module and/or the transferring of stored information from the memory module to the cellular telephone internal memory.

These and other features and advantages of the present invention will become more clear when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation of a first embodiment of the cellular telephone back-up system of the present including representative block diagrams of the cellular telephone and the memory modules;

FIG. 2 is a schematic representation of an alternative embodiment of the cellular telephone back-up system of the present including corresponding block diagrams of the cellular telephone and an external transfer module type interface;

FIG. 3 is a partial interior view of one embodiment of an external transfer module;

FIG. 3A is a partial interior view of another embodiment of an external transfer module;

FIG. 4 is a bottom view of an embodiment of the external transfer module illustrating a USB type connectivity port;

FIG. 5 is a schematic representation illustrating the memory module's connectivity with external devices utilizing an embodiment of the external transfer module;

FIG. 6 is an illustration of the memory module contained in one embodiment of a memory module storage device;

FIG. 6A is a rear view of an embodiment of the memory module storage device;

FIG. 7 is an illustration of an alternative embodiment of the memory module storage device;

FIG. 7A is a side view of the embodiment of FIG. 7;

FIG. 8 is a flow diagram illustrating the operation of the cell phone back-up system of the present invention in a first embodiment thereof associated with a GSM type cellular telephone which includes the interface therein;

FIG. 9 is a schematic illustration of various modes of operation for different types of memory modules;

FIG. 10 is a schematic illustration of information transfer between multiple telephones;

FIG. 11 is a schematic representation of a limited network access using the memory module of the present invention; and

FIG. 12 is an illustration of one embodiment of the reader/writer unit.

Like reference numerals refer to like parts throughout the several views of the drawings.

### DETAILED DESCRIPTION OF THE PREFERRED EMBODIMENT

Showing throughout the Figures, the present invention is directed towards a cellular telephone back-up system, generally indicated as 10. In particular, the cellular telephone back-up system 10 is structured and configured for use in connection with a cellular telephone 50. The cellular telephone 50 may be of any conventional brand and/or model and may be used in connection with and of a variety of service carriers. As such, the cellular telephone 50 is preferably of the type which includes an input structure 51, such as a keypad, joy stick, touch screen, voice activated input or other input structure, a battery 54 and/or ac connector so as to effectively power the cellular telephone 50, as well as a conventional internal processor structure. More specifically, the internal processor as best viewed in the schematic representation 53 of the cellular telephone, preferably will include an internal memory 52 on which a quantity of personal data is maintained. For example, with today's conventional cellular telephones 50 an often large volume of personal data may be maintained in the internal memory 52 for a variety of uses or applications. These uses may include a large telephone/contacts directory including telephone numbers, addresses, etc., as well as a calendar, a notepad, a variety of graphics, games, ring tones, etc. Indeed, it is recognized, that the customization, expandability and versatility of a large number of features is often a primary selling point for a cellular telephone 50.

Looking further detailed to the cellular telephone back-up system 10 itself, it includes primarily a memory module, generally indicated as 20. The memory module 20 is structured to contain a quantity of information and may be provided in a variety of different memory storage formats and capacities. For example, RAM or Secure Digital type memory cards in any of a variety of available formats may be provided, or in the preferred, illustrated, embodiment a memory module similar to a subscriber identification module or SIM type memory card as may be conventionally utilized in GSM type cellular telephones and including a processor chip 21 may be preferred. Furthermore, the preferred memory module 20 is compact and interchangeable and may include its own internal processor, as best seen in the schematic diagram 22, such that in addition to merely including storage capabilities, it may also include a certain degree of processing capabilities as well.

The Memory module 20 is structured to contain a quantity of information, of varying types and formats, thereon. In the illustrated embodiment the information that is contained on the memory module 20 includes primarily a back-up copy of all or a portion of the personal data that has been maintained on the internal memory 52 of the cellular telephone 50, and which is retrieved as it will be described subsequently. As a result, if a user's cellular telephone is lost or damaged or the user simply desires a new telephone, the user's personal data will be maintained secure and available for immediate and facilitated transfer to a new or repaired cellular telephone. Additionally, however, in an alternative embodiment of the present invention, the memory module 20 may contain a variety of different types of information in addition to and/or instead of a back-up copy of a user's personal data. For example, this information may be pre-stored on the memory module 20 and/or transferred to the memory module from another source, as will be described.

In one embodiment the memory module 20 may be pre-configured to contain at least one utility telephone number that can be effectively transferred to the cellular telephone, as needed. For example, the memory module 20 of the present invention may be provided as a promotional item, security item, and/or utility item for the benefit of a user, such as a user traveling to a new area. In such an embodiment, a user traveling in a new city may benefit from a variety of different utility telephone numbers, including local service facilities, emergency telephone numbers, and/or recreational and/or touristic telephone numbers in the case of recreational and/or business travel. Indeed, such utility numbers could be particularly beneficial for international travelers. As such, the memory modules 20 with the utility telephone numbers thereon may be provided for sale and/or free distribution as part of a promotion, the additional information as well as the back up feature providing an incentive for purchase and/or use.

In addition to and/or instead of one or more utility telephone numbers, advertising information may also be provided on the memory module 20, and/or one or more different types of utility items, such as ring tones, auxiliary applications including games, calendars, schedules, applications, music files, photos, etc., and/or graphical items including screen savers, graphical icons, photographic images, etc. In such embodiments, by providing one or more of these additional value added features to the memory module 20, a substantially increase benefit can be provided to the ultimate end user of the memory module 20, and a substantial incentive for its use, and accordingly their exposure to the promotional or advertising information, can be provided. For example, a memory modules 20 may be provided as free or very low cost promotional type items wherein the back-up capability thereof and/or other value added features on the memory module 20 provide substantial incentive for use, use necessarily resulting in exposure to the promoter's message, either on the memory module storage device 40, as will be described, or in the form of information conveyed to the user using the cellular telephone, such as on the display and/or via the speaker of the cellular telephone 50. Accordingly, substantial motivation for the use of the cellular telephone back-up system 10 of the present invention can be provided, as well as a variety of added benefit to the users, benefits which traditionally had to be purchased or obtained using complex downloads, programming and/or SMS type messages.

Looking further to the cellular telephone back-up system of the present invention, the system further includes an interface. In particular, the interface is structured to communicatively connect the memory module 20 with the internal memory 52 of the cellular telephone 50, thereby effectively allowing for a data transfer therebetween. Moreover, transfer programming is also provided, the transfer programming being accessible by the user, such as utilizing the input structure of the cellular telephone, and being structured and configured to direct the information transfer between the internal memory of the cellular telephone 50 and the memory module. Also, if desired, the transfer programming can be in the form of a tool kit that can be used to modify data and information. For example, the tool kit can be used to manually or automatically convert international or long distance numbers to appropriate universal calling standards.

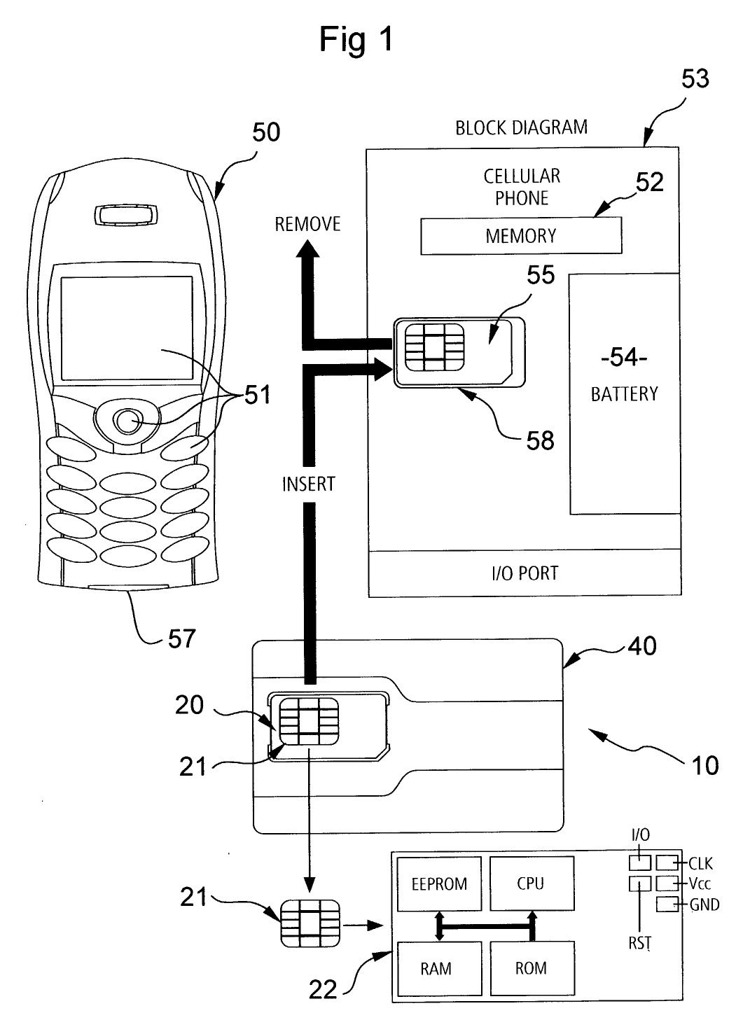

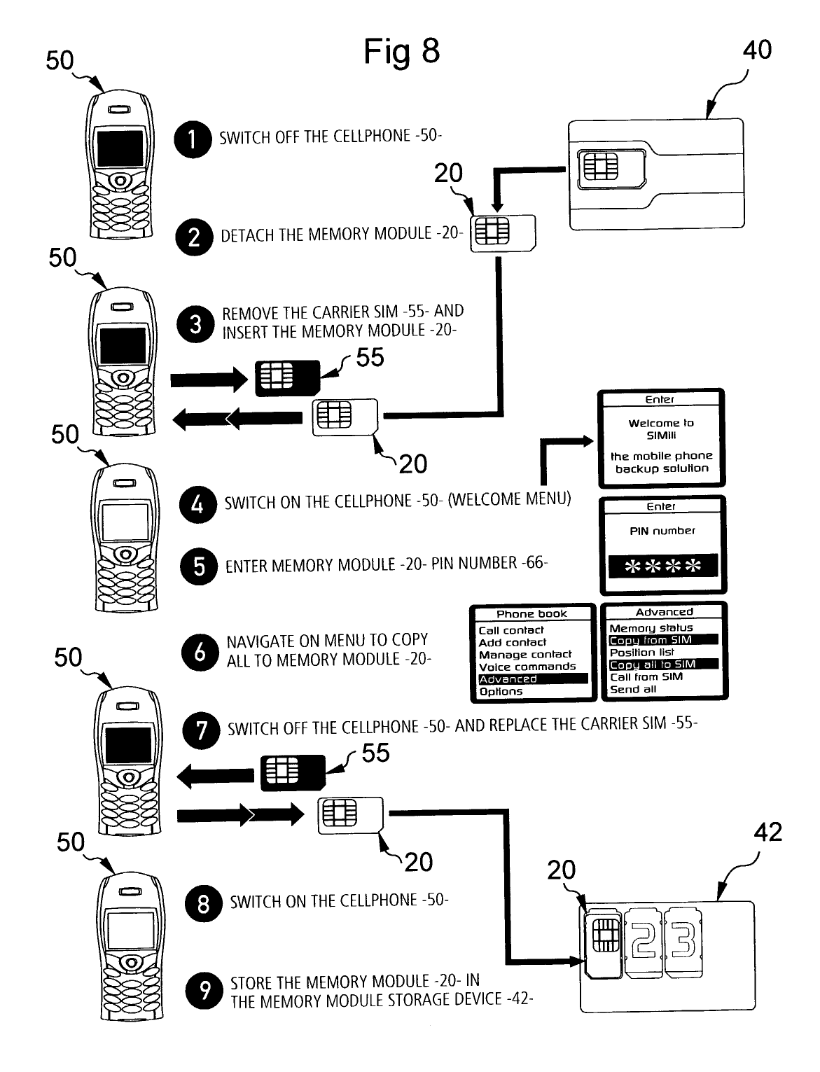

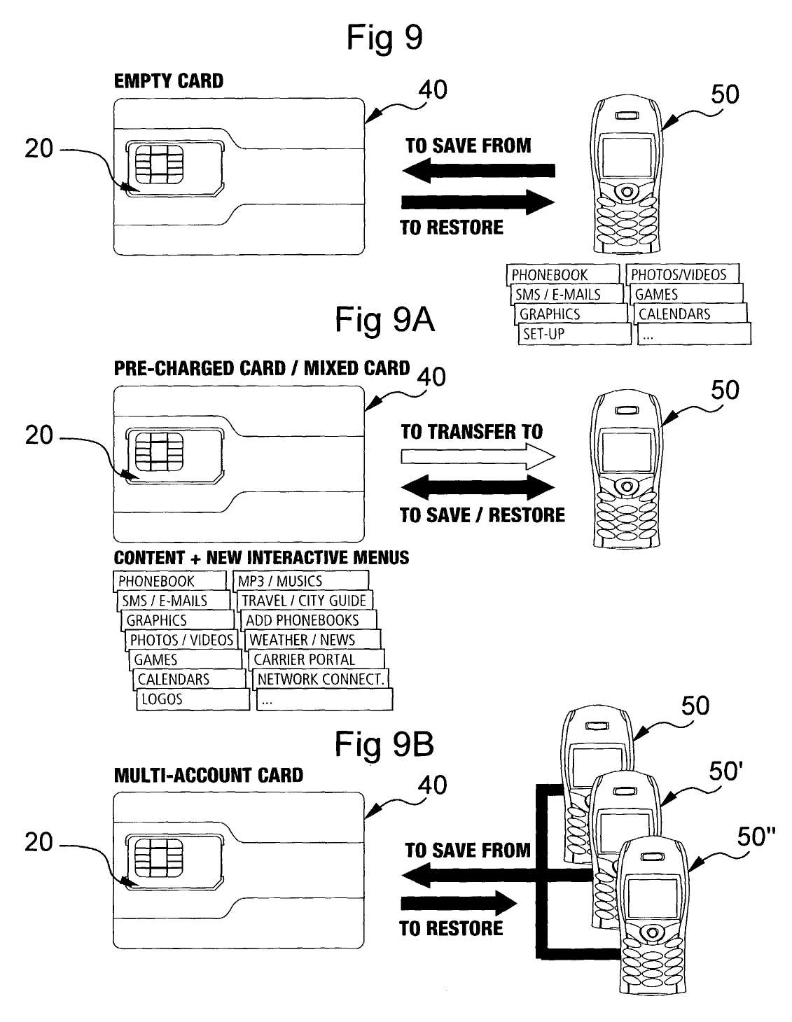

Looking first to the embodiment of the FIG. 1, it is recognized that one primary variety of cellular telephone includes GSM type cellular telephone which necessarily includes a primary SIM card 55 already contained therein within a SIM card connector 58. In such an embodiment, the SIM card connector 58, and/or an additional SIM card connector that may already be pre-configured within the body of the cellular telephone 50, define the interface by which the memory module 20 can be effectively and communicatively connected with the internal memory 52 of the cellular telephone 50. Of course, in this regard it is recognized that the cellular telephone 50, whether or not a GSM type phone, may also have a specific, dedicated interface for the memory module 20 built in, in a format that corresponds the memory module 20. Nevertheless, in such an embodiment wherein the interface is defined in the cellular telephone 50, the memory module 20 is effectively introduced into the interface 58, such as in the schematic illustration of FIG. 8, and as needed the primary SIM card 55 of the cellular carrier which is already within the cellular telephone is first removed. In such an embodiment it is also noted that the primary SIM card 55 may also contain some personal data which may either be transferred to the memory module directly or via the cellular telephone's internal memory.

With the memory module 20 communicatively connected via the interface, the transfer programming can then achieve the desired information transfer between the cellular telephone 50 and the memory module 20. In this regard, it is understood that the transfer programming may be pre-stored on the internal memory 52 of the cellular telephone either during initial programming of the cellular telephone and/or by effectively loading of the transfer programming on the internal memory 52 of the cellular telephone using any conventional means, including during a prior backup. Moreover, in an embodiment wherein a separate interface is provided for the memory module 20 such that the primary SIM card 55 from the carrier may remain in place within the cellular telephone 50, the transfer programming may also be provided on that primary SIM card. In still another preferred embodiment, however, the transfer programming is preferably contained on the memory module 20 itself, thereby allowing for effective communication between the memory module 20 and the internal memory 52 of any cellular telephone 50 without having to previously prepare or program the cellular telephone 50.

The transfer programming is preferably structured to copy at least some, but possibly all of the personal data that is being maintained at least in the internal memory 52 of the cellular telephone 50 to the memory module 20. In this regard, the memory module 20 may come in a variety of sizes, standards, operating systems, performance, speed, and capacities, including newly released and yet to be devised configurations and qualities. As a result, all of a particular user's personal information can be effectively backed-up, such as the large number of telephone numbers that may be stored therein. Accordingly, in case the cellular telephone is exchanged, lost and/or otherwise damaged, the user will not have lost the often large volume of personal information that has typically taken a long time to effectively compile.

In addition to and/or instead of copying their personal information from the internal memory 52 of the cellular telephone to the memory module 20, the transfer programming may also be configured so as to copy information from the memory module 20 to the internal memory 52 of the cellular telephone 50. Such transfer from the memory module 20 to the cellular telephone has particularly benefit in the previously recited embodiment whereby additional content is provided on the memory module 20 and is to be transferred to the cellular telephone 50 for future utilization at a time after the back-up memory module 20 has been effectively removed from its communicative connection with the cellular telephone 50. Also, however, this transfer from the memory module 20 to the cellular telephone 50 is especially beneficial in a circumstance wherein a user changes their cellular telephone 50. For example, if a user changes their cellular telephone, whether it be merely as an upgrade or because their original cellular telephone is damaged and/or otherwise not usable, the new telephone has little if any personal information thereon, such as including only a few limited applications and/or features. The user must thereby go through the burden of manually inputting information from the old cellular telephone to the new cellular telephone. Utilizing the present invention, a user is able to effectively back-up all their personal information and transfer it to their new cellular telephone in a rapid and effective manner. Moreover a variety of other types of personal data, such as ring tones, applications, graphics, etc., which often had to be purchased, are not lost merely because a new cellular telephone has been purchased, but rather they may be also be effectively transferred from one cellular telephone to another, a feature that is not conventionally available.

Looking further to the interface of the present invention, in addition to or instead of an interface which is built-in directly into the cellular telephone 50, as in the case with a SIM card connector and/or other dedicated type of interface for the memory module 20, the interface may also include an external transfer module 30. In particular, the external transfer module 30 is preferably structured to be communicatively connected with the memory module 20 as well as the cellular telephone 50, and therefore effectuates communication therebetween. In this regard, it is understood that the memory module 20 may be integral and/or internally provided in the external transfer module, or as in the preferred embodiment, the memory module 20 may be a separate and distinct interchangeable memory module 20 which is effectively introduced and/or otherwise communicatively connected with the external transfer module 30 during use. Moreover, the external transfer module 30 may be independently powered by its own battery or charging system and/or receive some or all of its power from the cellular telephone via the communicative connection.

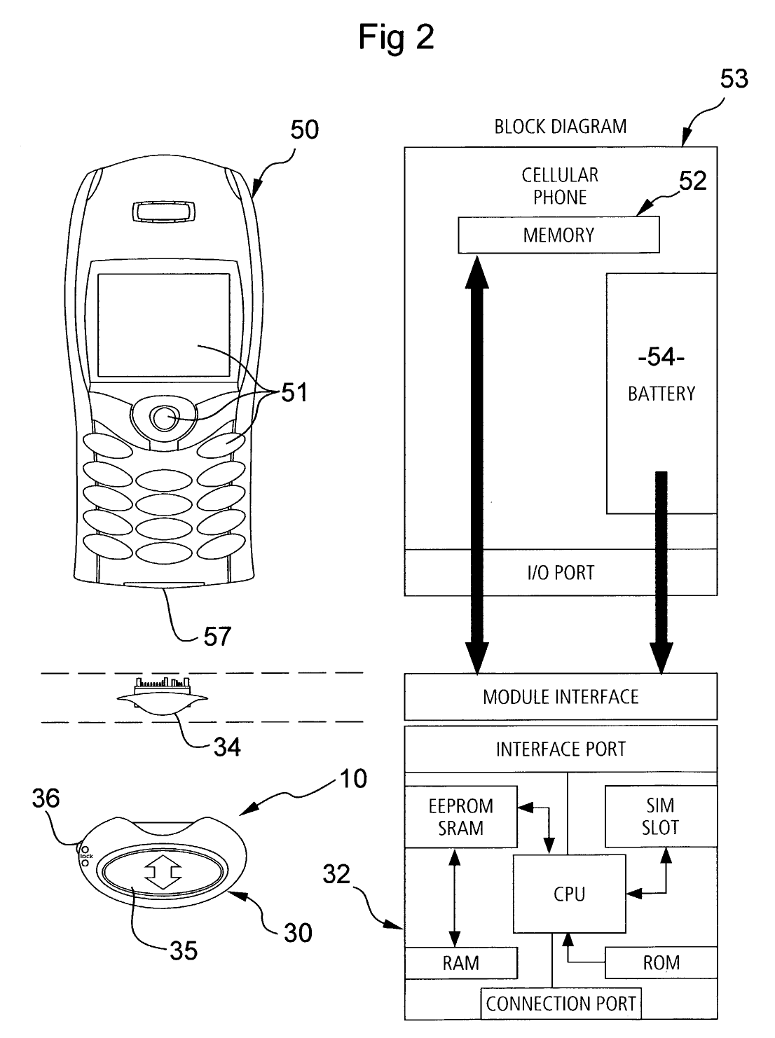

In one embodiment of the present invention, the external transfer module 30 is structured to be connected, such as utilizing a standard adaptable connector 34 with the telephone interface 57 of the cellular telephone 50. Specifically, all cellular telephones 50 usually include a telephone interface 57 which allows the effective coupling of an auxiliary item, such as a battery charger, wireless head set, etc. In one embodiment of the external transfer module 30 it is preferably structured to be coupled with this telephone interface 57 for appropriate communicative connection therewith. In this regard, it is noted that a variety of different brands and types of cellular telephones 50 often include a variety of different types of telephone interfaces 57, including wireless interfaces. As a result, the external transfer module 30 may be expressly configured for a particular brand of cellular telephone 50, including a configuration wherein pure wireless communication with the cellular telephone interface is achieved, or as in the embodiment of FIG. 2 an appropriate adaptor 34 may be provided. For example, the adaptor plug 34 may be provided and structured to be operatively coupled with the external transfer module 30, the adaptor 34 is also, however, specifically configured and/or dedicated for a particular brand and/or model of cellular telephone 50, thereby effectively achieving the communicative connection therebetween. A user need only have a single external transfer module 30 and one or more corresponding adaptors 34. Once coupled with the cellular telephone 50, the external transfer module 30 is thereafter able to effectively achieve communication between the memory module 20 and the internal memory 52 of the cellular telephone 50.

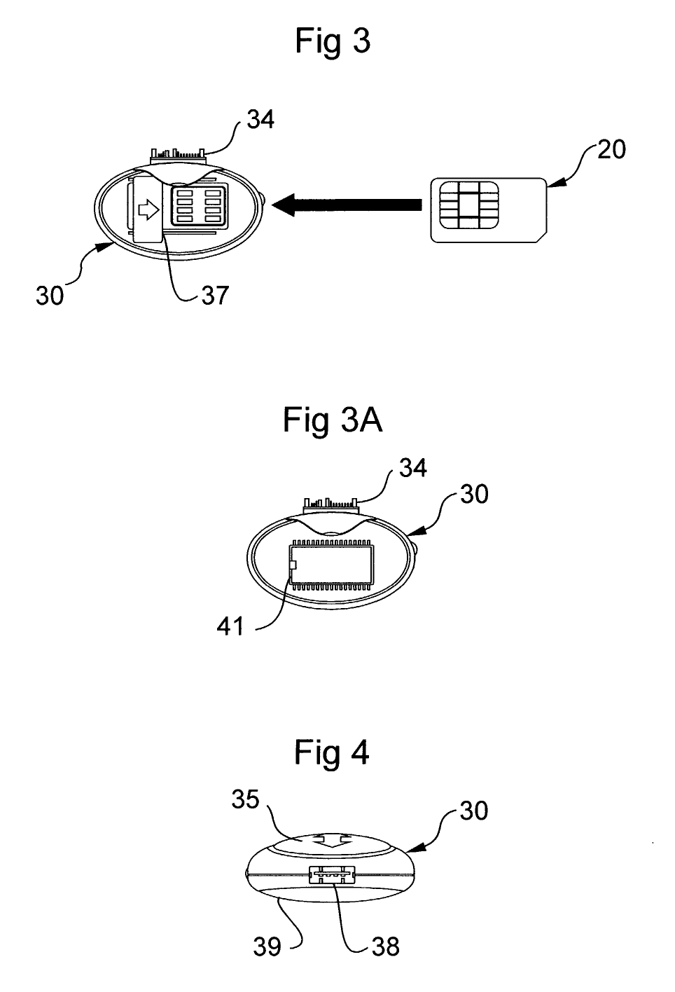

Looking to the embodiment of FIG. 3 wherein the memory module 20 is a separate interchangeable memory module 20 that is introduced into the external transfer module 30, a slot or other type of opening, such as in a rear cover 39 may be provided whereby a connector 37 within the external memory module 30 receives the memory module 20 for communicative connection therebetween. Of course, it is understood that a variety of different connections between the external memory module 20 and the external transfer module 30 may be provided depending upon the nature of the memory module 20 and/or whether a compact type of memory module 20 is provided. Also, in the embodiment of FIGS. 2 and 3A wherein the external memory module 30 includes an internal processor 41 and internal memory, such as an EEPROM and as best seen in schematic 32, coupling with an interchangeable memory module 20 may not be required. Nevertheless, as yet another embodiment, a combination system wherein a certain amount of information is contained directly on the external transfer module 30, but a separate memory module 20 is still capable of being received may also be provided, in such an embodiment as well as prior embodiments, the internal memory of the external transfer module 30 may define the memory module 20 or may merely store and run the transfer programming.

Although as previously recited, the transfer programming may be accessible utilizing the interface of the cellular telephone 50, it is also contemplated that the external transfer module 30 may include an input actuator 35 by which appropriate transfer and/or back-up of information may be effective achieved. For example, in the embodiment of FIG. 2 a large transfer button 35 may be provided, to transfer button not only initiating effective back-up transfer and/or synchronization between the cellular telephone and the memory module 20, but also serving as an indicator which may change colors and/or provide an interactive display as to the status of the information transfer and/or the available functions. Also a memory lock 36 may also be provided as a manual and/or electronic indicator to prevent deleting of information on the memory module 20 and thereby requiring an affirmative step if the back-up information on the memory module 20 will be deleted. For example, the actuation of the memory lock 36 may serve as a signal to the transfer programming that a deletion step cannot be performed.

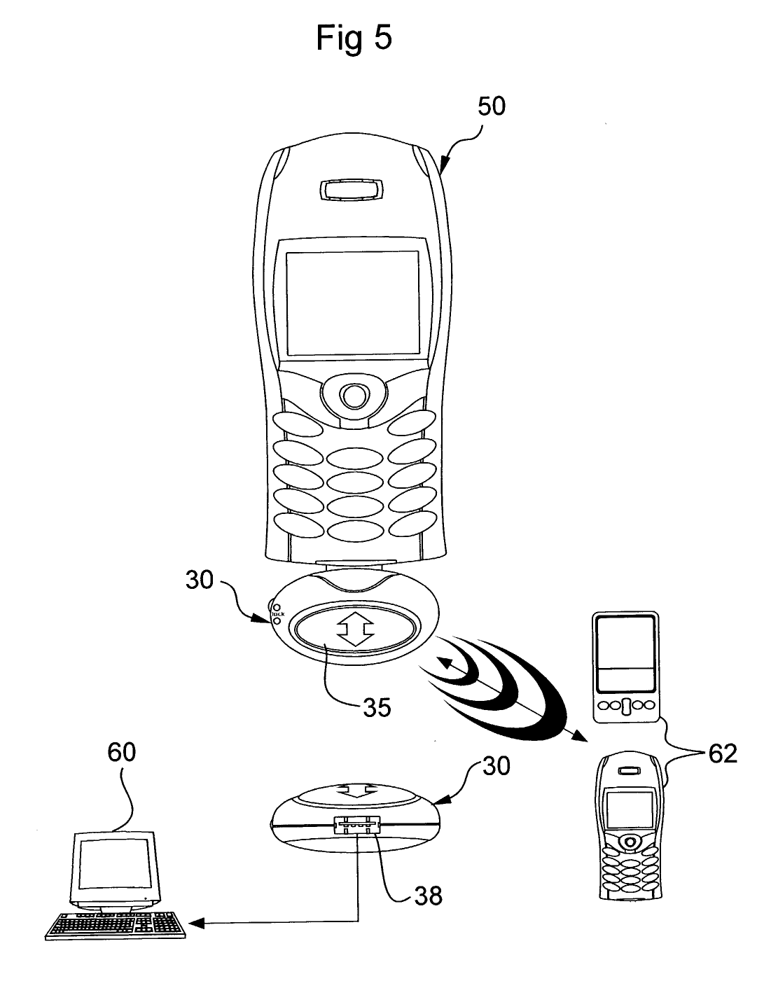

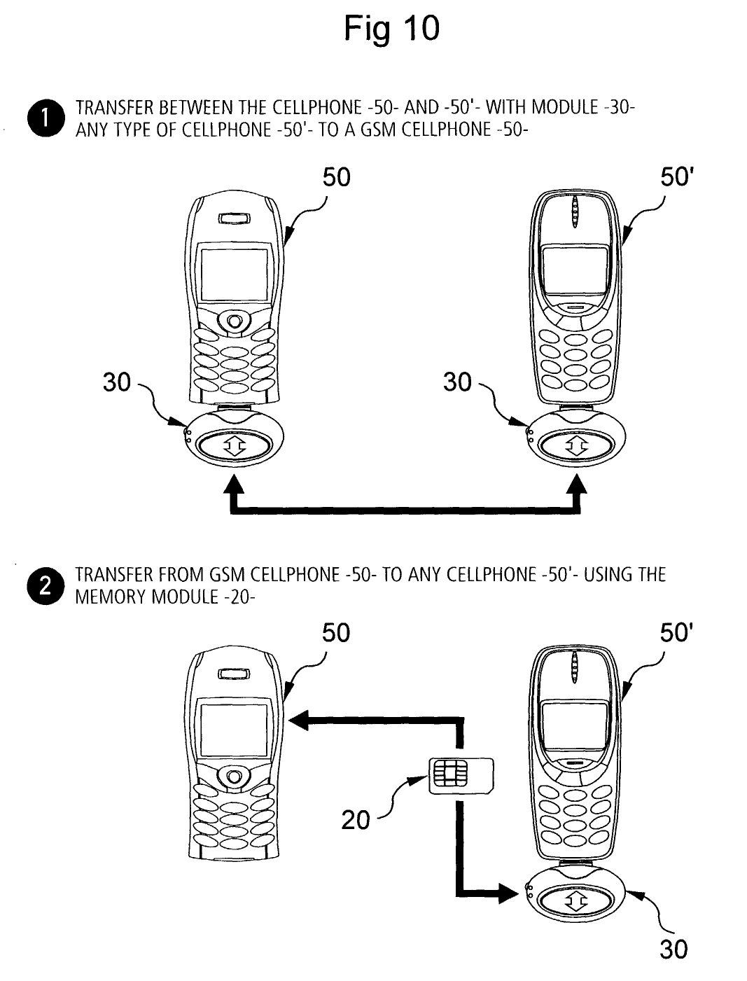

In use, the external transfer module 30 is especially beneficial for use with a variety of cellular telephone which are not of the GSM type and do not include GSM interfaces and/or a dedicated interfaces for the memory module 20. Additionally, however, such can be substantially beneficial for providing effective transfer of information between these different types of cellular telephone technologies, as in FIG. 10. For example, a user who has a non-GSM type telephone may provide a back-up of their personal information onto the memory module 20 using the external transfer module 30, and can subsequently transfer the information to the GSM or other type telephone, either using the built in SIM interface or using the external transfer module 30. The external transfer module may also, however, include structure so as to effectively provide for communication with another external device, as illustrated in FIG. 5, including for example, a PDA or other telephone 62, a computer 60, etc. In this regard, a variety of different types of communicative interfaces may be provided. For example, in one embodiment the memory module 20 may merely be operatively connected with the other device. Alternatively, however, and as illustrated in the embodiment of FIGS. 4 and 5, the external transfer module 30 may include one or more alternate types of interfaces, including a wireless and/or BlueTooth type interface for wireless communication with the peripheral device, a wired interface including a USB, firewire or other wired type interface 38, and/or any other type of connector which allows for communicative interaction between the devices. In such an embodiment, information can be transferred directly from the memory module 20 to one of these peripheral devices while the memory module 20 is connected or not connected to the cellular telephone 50. Indeed, a direct transfer from the cellular telephone 50 to the peripheral device may also be achieved, without any information actually being stored on the memory module 20.

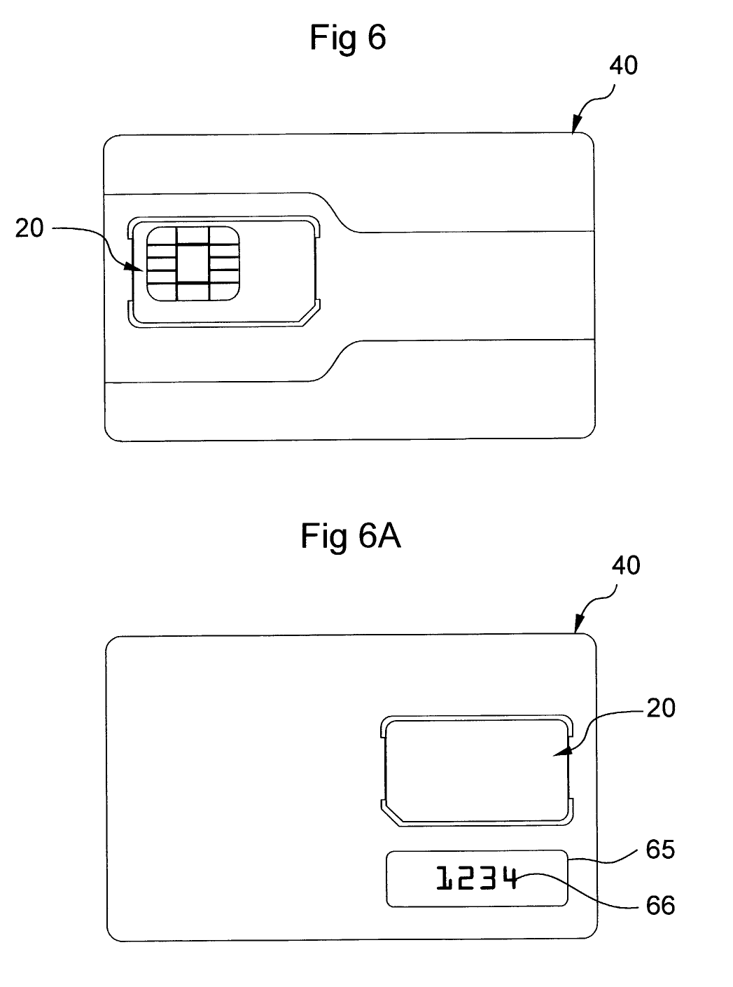

As indicated, in the preferred, illustrated embodiment the memory module 20 is preferably a substantially compact portable memory device, such as a SIM memory module, RAM card, secure digital memory card, etc. In such an embodiment, a memory module storage device may also be provided so as to effectively hold the memory module 20 before or after use. For example, in the embodiment of FIG. 6, it is seen that the memory module 20 may be initially distributed as part of a storage card 40 wherein the memory module 20 either fits into a re-useable slot or other holding structure, and/or is formed as part of the card 40 and can be snapped or cut out for use. Such a storage card 40 also allows for the inclusion of various advertising and other promotional information, and prevents the loss of the smaller memory module 20 prior to use and/or after use if an appropriate configuration for holding the memory module 20 subsequent to its removal is provided.

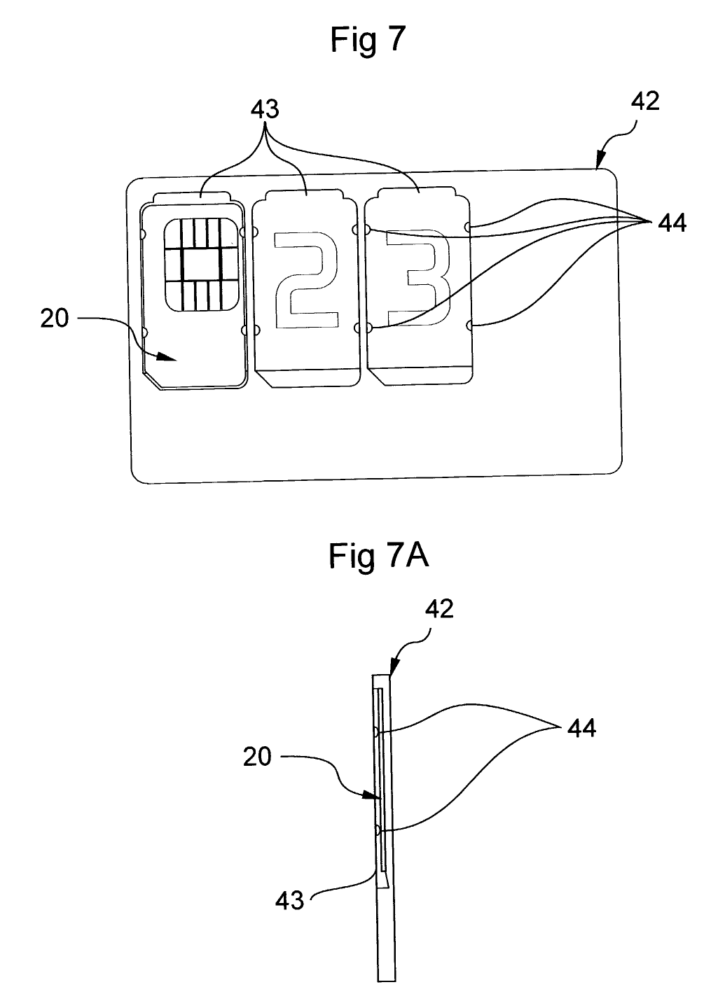

Turning to the embodiment of FIG. 7, in such an embodiment the memory module storage device 42 includes one or a plurality of memory module receiving slots 43 define therein. Specifically, the memory module storage device 42 is preferably substantially thin, such as the size of a credit card, so as to provide for facilitated and easy storage, such as in a user's wallet. In the preferred embodiments, the slots 43 include an at least partially resilient perimeter configuration that will effectively receive and retain the memory modules 20 therein. For example, a somewhat snug type fit can be provided, the resilient characteristic allowing for the snug encasement of the memory module 20 within the holder 42. Moreover, if desired an overall resilient configuration may be provided so as to facilitate removal of the memory module 20, and/or a gap or removal slot may also be provided so as to facilitate the removal of the memory module 20. Additionally, it is noted that in defining at least a portion of the perimeter of the slot as being resilient, such may include the inclusion of one or more resilient or rigid protrusions 44 that further help to retain and/or hold the memory module 20 within the memory module storage device 42, either by a friction fit, or by engaging corresponding recesses in the memory module 20.

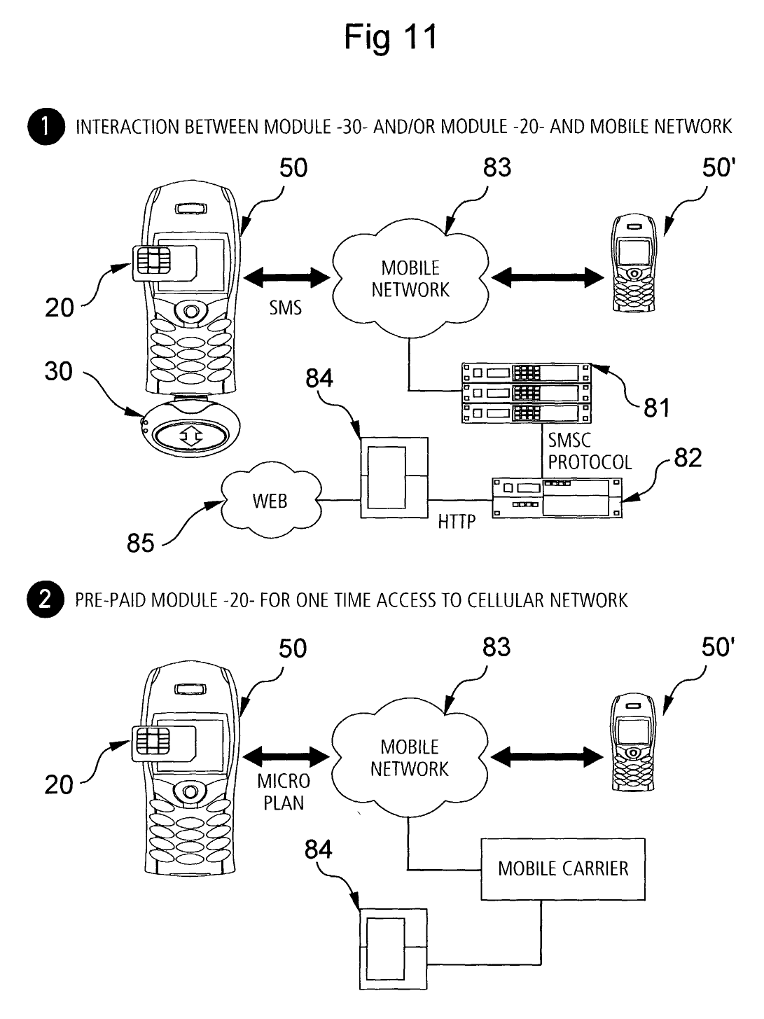

Finally, it is recognized that the memory module 20 may include one or more storage modules defined thereby to contain the information. The storage modules may include separate storage devices or a mere partitioning of the main storage using programming. For example, a user may have multiple cellular telephones 50, 50′, 50″ and may want to keep the personal information from each separate from one another. Alternately, a group of users, such as a family, may want to use a single memory module 20 to store all personal information from various telephones separate from one another. In such an embodiment the transfer programming can help achieve appropriate access to or from the corresponding storage module of the overall memory module. Also, a security module may be provided, whether or not one or more storage modules are defined. The security module may include a password protection of the information or securing of the information or a specific storage module such that an unauthorized user cannot access and/or download the personal data stored on the memory module 20. Moreover, such security structure can be utilized so as to prevent unauthorized use of the content, including the requiring of a pin number in order to initially access pre-installed content on the memory module 20. As an additional feature, either not utilizing or utilizing the security structure, such as the pin number, the information contained on the memory module 20 may be such as to allow a user to make one or a limited number of calls or accesses to a mobile network 83 managed by a remote access server 84, with or without the need to use their existing carrier minutes. As illustrated in FIG. 11, this one or limited number of calls can be made for normal telephony to a remote telephone 50′ as a pre-paid calling feature, and/or may be used as an automatic dial up of an access telephone number, such as to the internet 85 a remote SMS center and/or access gateway 82, whereby certain content and other information is downloaded to the telephone and/or the memory module 20. As a result, the content on the memory module 20 can always remain current. In such an embodiment, and as seen in FIG. 6A, the storage card 40 may include one or more scratch off labels 65 or other concealing structure beneath which the pin number(s) 66 may be stored.

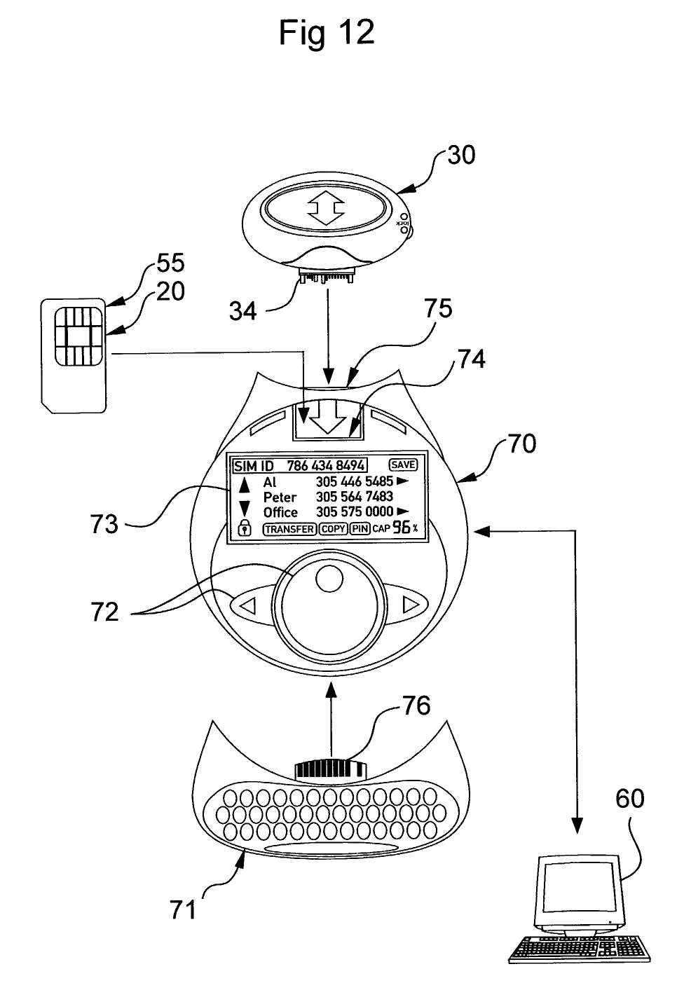

Looking to FIG. 12, a reader/writer unit 70 may also be provided and structured to receive the memory module 20 or SIM card 55 directly via a card slot 74, or be connected with the external memory module 30, such as via a suitable connector 75. This unit 70 may also include a display 73 and input device whereby the information can be viewed and/or modified, such as using an integral or separate printer 1 which can be coupled via a connector 76 to the unit 70. Also, computer 60 communication can also be achieved using the reader/writer unit 70, and indeed, the external memory module 30 itself may function as the reader/writer unit if desired.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. For use with a cellular telephone having an input structure and an internal memory on which a quantity of personal data is maintained, a cellular telephone back-up and media system comprising:
a) a memory module structured to contain a quantity of information;
b) an interface said interface structured to communicative connect said memory module with the internal memory of the cellular telephone; and
c) transferring programming accessible utilizing the input structure of the cellular telephone and structure to direct information transfer between the internal memory of the cellular telephone and said memory module.

2. A cellular telephone back-up and media system as recited in claim 1 wherein said memory module is compact and interchangeable.

3. A cellular telephone back-up and media system as recited in claim 2 wherein said memory module includes a SIM card.

4. A cellular telephone back-up and media system as recited in claim 3 wherein said interface includes a SIM card connector defined in the cellular telephone.

5. A cellular telephone back-up and media system as recited in claim 4 wherein said memory module is structured to replace a primary SIM card contained in a SIM card enabled cellular telephone.

6. A cellular telephone back-up and media system as recited in claim 1 wherein said transfer programming is structured copy said personal data from the internal memory of the cellular telephone onto said memory module.

7. A cellular telephone back-up and media system as recited in claim 1 wherein said transfer programming is structured to copy said quantity of information from said memory module to the internal memory of the cellular telephone.

8. A cellular telephone back-up and media system as recited in claim 1 wherein said memory module is structured to contain at least one utility telephone number, said transfer programming structured to facilitate calling of said utility telephone number using the cellular telephone.

9. A cellular telephone back-up and media system as recited in claim 1 wherein said memory module is structured to contain advertising information, said transfer programming structured to convey said advertising information to said user via the cellular telephone.

10. A cellular telephone back-up and media system as recited in claim 1 wherein said memory module is structured to contain at least one utility item, said transfer programming structured to copy said at least one utility item to the internal memory of the cellular telephone.

11. A cellular telephone back-up and media system as recited in claim 10 wherein said utility item includes at least one ring tone

12. A cellular telephone back-up and media system as recited in claim 10 wherein said utility item includes at least one auxiliary application.

13. A cellular telephone back-up and media system as recited in claim 10 wherein said utility item includes at least one graphical item.

14. A cellular telephone back-up and media system as recited in claim 1 wherein said memory module is structured to contain said transfer programming.

15. A cellular telephone back-up and media system as recited in claim 1 further comprising a security module structured to secure said quantity of information on said memory module.

16. A cellular telephone back-up and media system as recited in claim 1 wherein said memory module includes at least two storage modules structured to contain said quantity of information.

17. A cellular telephone back-up and media system as recited in claim 1 wherein interface includes an external transfer module structured to be communicatively connected with said memory module and the cellular telephone.

18. A cellular telephone back-up and media system as recited in claim 17 wherein said external transfer module is structured to communicate wirelessly with the cellular telephone.

19. A cellular telephone back-up and media system as recited in claim 17 wherein external transfer module is structured to be coupled with a telephone interface of the cellular telephone.

20. A cellular telephone back-up and media system as recited in claim 17 wherein said external transfer module is structured to receive said memory module therein.

21. A cellular telephone back-up and media system as recited in claim 17 wherein said external transfer module includes a memory lock structure to prevent deleting of said information on said memory module in said external transfer module.

22. A cellular telephone back-up and media system as recited in claim 17 wherein said external transfer module is structured to communicate wirelessly with other wireless enabled devices.

23. A cellular telephone back-up and media system as recited in claim 17 wherein said external transfer module includes a connection port structured to facilitate communication with a peripheral computer processor device.

24. A cellular telephone back-up and media system as recited in claim 1 further comprising a memory module storage device structured to hold said memory module when not in use.

25. A cellular telephone back-up and media system as recited in claim 24 wherein said storage device comprises a storage card having a memory module receiving slot define therein.

26. A cellular telephone back-up and media system as recited in claim 25 wherein said a memory module receiving slot includes and at least partially resilient perimeter configuration structured to receive and retain said memory module.

27. For use with a cellular telephone having an input structure and an internal memory on which a quantity of personal data is maintained, a cellular telephone back-up and media system comprising:
a) a memory module structured to contain a quantity of information;
b) an external transfer module communicatively connected with the cellular telephone and defining an interface structured to communicative connect said memory module with the internal memory of the cellular telephone; and
c) transferring programming structured to direct information transfer between the internal memory of the cellular telephone and said memory module.

28. A cellular telephone back-up and media system as recited in claim 27 wherein said memory module is compact and interchangeable.

29. A cellular telephone back-up and media system as recited in claim 28 wherein said external transfer module is structured to receive said memory module removably therein.
